(19) United States
(12) Patent Application Publication
(10) Pub. No.: US 2018/0328078 A1
(43) Pub. Date: Nov. 15, 2018

(54) DEVICE FOR MONITORING AND SECURING MOBILE ASSETS

(71) Applicant: Commercial Finance Corp., S. de R.L., Panama City (PA)

(72) Inventors: Mauricio Lloreda, Bogota (CO); Ivan Lopez, Bogota (CO)

(21) Appl. No.: 15/774,271

(22) PCT Filed: Nov. 7, 2016
(86) PCT No.: PCT/US16/60846

§ 371 Date: May 7, 2018

(30) Foreign Application Priority Data
Nov. 5, 2015 (US) 62251577
Nov. 5, 2015 (US) 62251584

(51) Int. Cl. E05B 39/00; E05C 19/18; E05B 83/02; E05C 7/00; E05B 45/06; H04W 4/38

(52) U.S. Cl. CPC E05B 39/005; E05C 19/188; E05B 83/02; H04W 4/029; E05B 45/06; H04W 4/38; E05B 2045/0695; E05C 7/00

(57) ABSTRACT

An improved monitoring and securing device is provided. Example embodiments provide a monitoring and securing device that includes a fastening system with an elongation and compression mechanism that allows it to be adapted to different topographies of the surface to which they are fastened and are designed to secure two irregular elements to form a connection. Thus, the improved monitoring and securing device can be simultaneously fastened to, for example, one right door and one left door that close to form a connection that is uneven in depth, while monitoring related events such as installation and removal of the monitoring and securing device, opening and closing of the movable entity's locking mechanism and doors, and other events.

### CROSS-REFERENCE TO RELATED APPLICATIONS

This application claims the benefit of U.S. Provisional Patent Application No. 62/251,584, filed Nov. 5, 2015; and U.S. Provisional Patent Application No. 62/251,577, filed Nov. 5, 2015, which applications are incorporated herein by reference in their entireties.

### TECHNICAL FIELD

The present disclosure relates to methods, techniques, and systems for monitoring and securing the cargo container of movable entities and, in particular, to methods, techniques, and systems for securing movable entities (mobile assets) such as trucks, vans, vehicles, or the like having double metal doors or similar locking mechanisms for closing a cargo container of the movable entity.

### BACKGROUND

Even though multiple types of systems and devices for monitoring movable entities have been disclosed, some of which allow securing a cargo container of the movable entity being monitored, for instance, those described by Patent Application Publication Nos. WO2014/117180 (Application No. PCT/US2014/013433 by Lloreda et al.), U.S. Pat. No. 9,260,896 (Issued Feb. 16, 2016 by Lloreda et al.), and US2009/0021369 (by Ulrich), among others, and which are included herein as a reference, these systems do not enable easy installation and uninstallation of the monitoring and securing device and allow functions associated with detecting the security of the cargo container and/or movable entity.

In addition, in many cases, the locking mechanism of a movable entity's cargo container, due to impact, dents, misuse or otherwise, does not fit precisely where the sealing connection of the cargo container should be otherwise perfectly aligned and at the same depth. Thus, the closing mechanism cannot form a perfect seal. For example, when a movable entity's cargo locking mechanism uses two doors that close to form a connection to seal the cargo, both doors of the cargo container frequently do not close at the same depth because of damages to doors or door hinges or to the body of the movable entity. Therefore, fastening a monitoring and securing device that, in addition to monitoring the position of the movable entity, monitors opening and closing of the cargo locking mechanism, becomes difficult and sometimes impossible depending on the fastening system used by the monitoring and securing device.

Furthermore, as shown in FIG. 1, many existing magnetic covers and protectors use fixed magnets to fasten a GPS (global positioning device) to a metal structure. However, none of them has a magnet system that allows adaptation to different topographies of the surface to which they are fastened or are designed to secure two misaligned elements to form a connection. Therefore, they could not be simultaneously fastened to, for example, one right door and one left door that close to form a connection that is uneven in depth, while still detecting related events such as door closing, opening, and/or leaning and installation and/or removal of the monitoring device, among other events.

### BRIEF DESCRIPTION OF THE DRAWINGS

FIG. 1 illustrates various existing devices for monitoring the location of mobile assets on the market that are attached to mobile assets by magnets.

FIG. 2 illustrates the underside of an example embodiment of the improved locking device with fasteners and a sensor array and connector.

FIG. 3 illustrates the top side of an example embodiment of the improved locking device where elements housed inside include a cover-guard, a battery and electronic transmission components for data transmission and communication.

FIG. 4 illustrates the mechanism that allows elongation and compression of the fasteners of the improved locking device to be able to adapt to different surface topologies.

FIG. 5 illustrates an exemplary way in which the improved locking device is installed on the binding of a locking mechanism of the cargo area of a mobile asset to monitor and secure a cargo area of the mobile asset.

FIG. 6 is an example block diagram of a cargo monitoring system that is able to operate with the improved locking device shown in FIGS. 2 and 3.

FIG. 7 is an example block diagram of an example computing system for implementing a cargo monitoring system integrating the improved locking device shown in FIGS. 2 and 3 according to an example embodiment.

FIG. 8 is an example block diagram showing sensing components of the improved locking device shown in FIGS. 2 and 3 according to an example embodiment.

### DETAILED DESCRIPTION

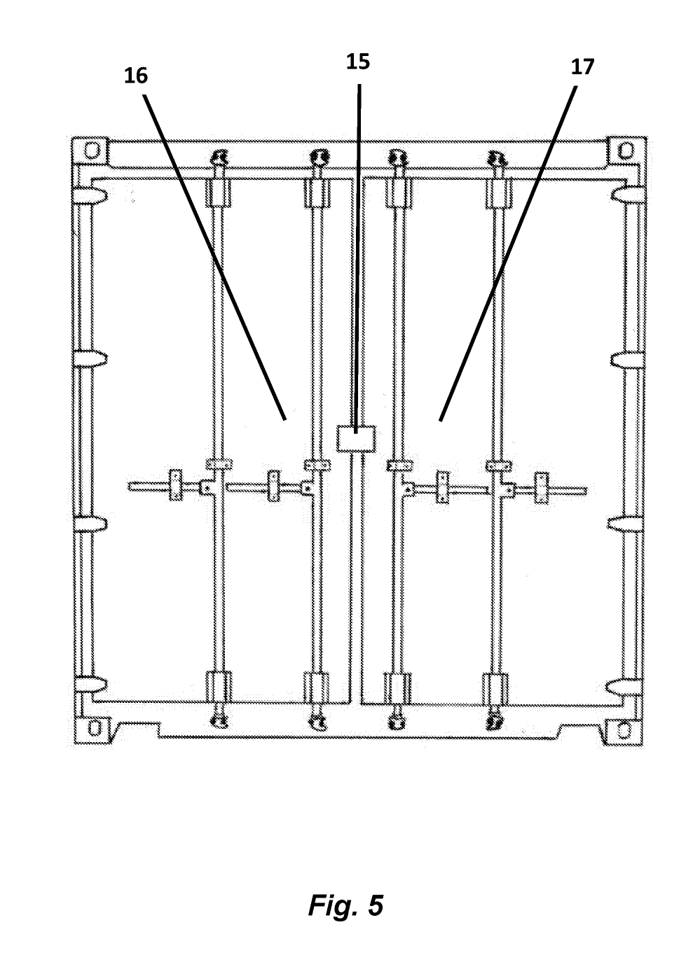

Embodiments described herein provide an enhanced monitoring and securing device for securing cargo stored in a cargo area of a mobile entity (also referred to as a mobile asset). Mobile entities include assets such as tracks, vans, cars, or other vehicles, drones, robots, or any entity/asset that may carry cargo. Example embodiments provide a mechanism that allows an improved monitoring and securing device to be installed and uninstalled easily, even on an uneven surface such as on doors that do not precisely join or seal due to damage, or wear and tear (irregular doors). The improved monitoring and securing device includes a fastening system with an elongation and contraction mechanism that allows it to be adapted to different topographies of the surface to which they are fastened and are designed to secure two irregular elements to form a connection. Thus, the improved monitoring and securing device can be simultaneously fastened to, for example, one right door and one left door that close to form a connection that is uneven in depth, while monitoring related events such as installation and removal of the monitoring and securing device, opening and closing of the movable entity's locking mechanism and doors, and other events. The improved monitoring and securing device may be quickly and easily installed on the “binding” (junction or joining area) of an active locking mechanism such as shown in FIG. 5.

The improved monitoring and securing device can be used to secure movable entities having double metal doors or similar locking mechanisms for closing their cargo containers, and is designed to allow quick and easy installation of the improved device. The monitoring and securing device secures the double metal doors or similar closing mechanism by adhering onto each side of the junction of the two doors or other closure, through an innovative fastening (or clamping) system, specifically made suitable to adapt and lock even when a deep gaps exist between the two separate surfaces (e.g. two metal doors). These gaps would otherwise prevent other securing mechanisms (other than the improved device described herein) from adapting and performing its securing functions due to the irregular surface being secured.

The innovative fastening system achieved by the improved monitoring and securing device operates through a system comprising springs and metal parts. It includes elements that adhere simultaneously to both sides of the junction of the locking mechanism of the cargo area of mobile entities, effectively closing the cargo area and securing the improved monitoring and securing device to the mobile entity. In some embodiments the adjustable elements of the fastening system are magnets; however, other connective mechanisms can be used as long as elongation and contraction (compression and extension) of the parts of the device can still be accomplished.

The improved securing and monitoring device includes multiple sensors that allow the monitoring and securing device not only to monitor and trace a mobile entity as such for position, estimated time of arrival, and the like, but also to detect and monitor proper or improper installation and removal of the monitoring and securing device, opening or closing of the doors of the movable entity, opening or closing the locking mechanism, removal of the doors, door leaning, and other detection of impact, tilts, crashes or blows, shock, light intensity, temperature, humidity, or values from other telemetry sensors. The monitoring and securing device also has components to transmit alarms and data wirelessly using a radio, cellular device, modems or/and satellite transmission, including location coordinates with GPS and/or other positioning systems.

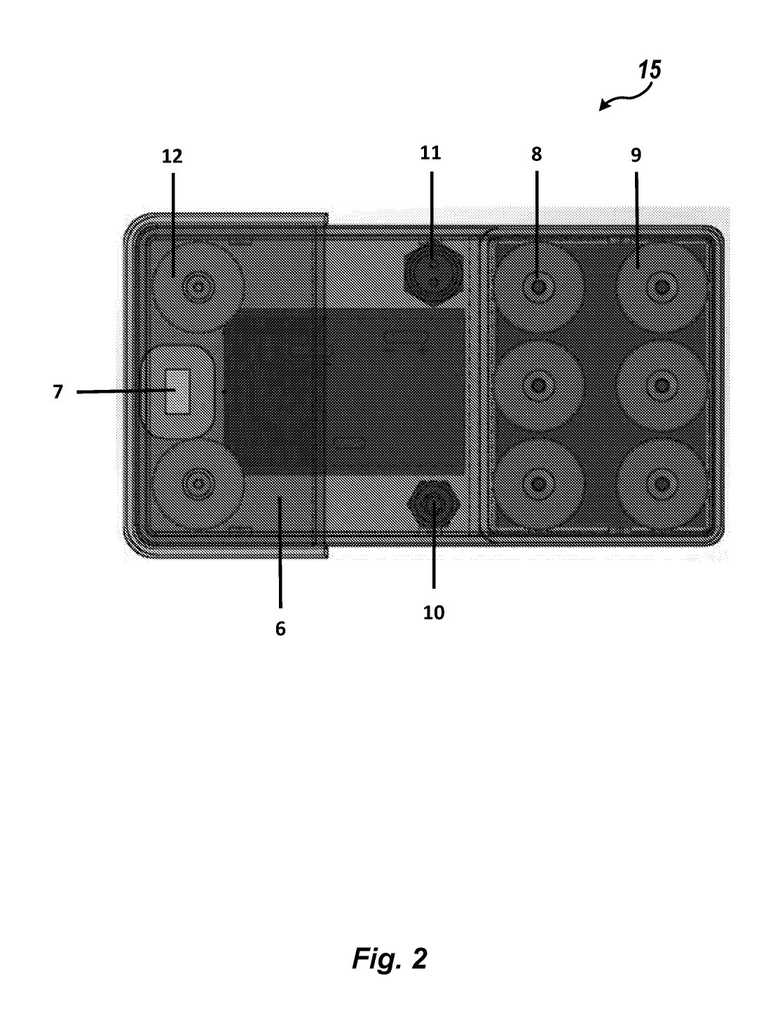

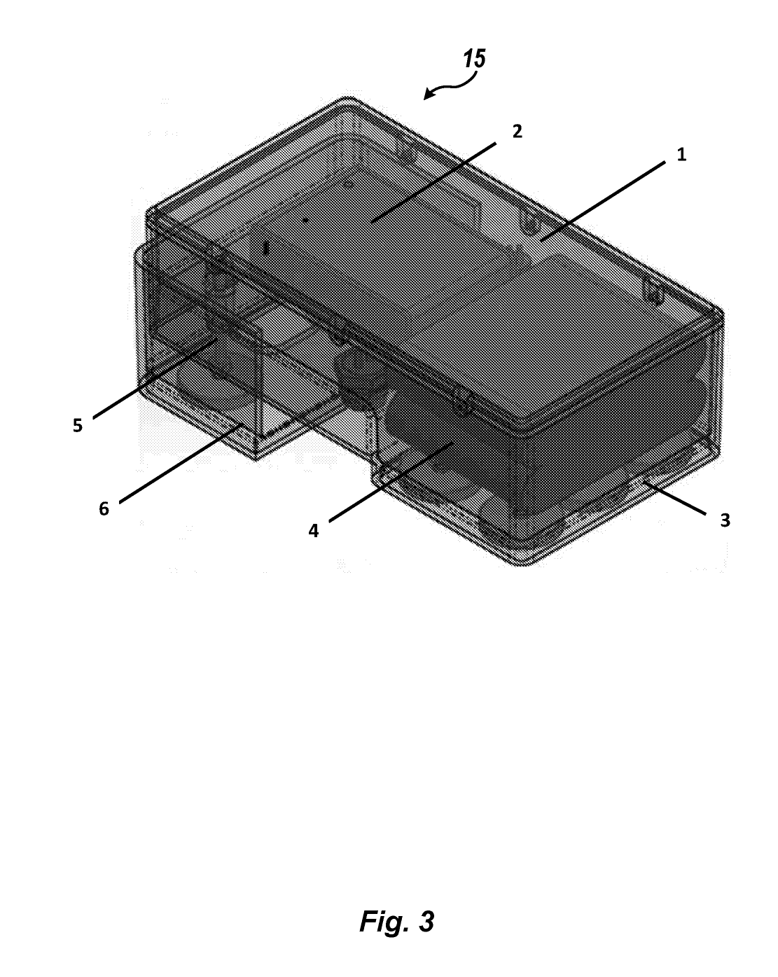

FIG. 2 is an illustration of the underside of an example embodiment of the improved locking device for monitoring and securing movable entities having double metal doors or similar locking mechanisms for closing the cargo container of such movable entities. FIG. 3 illustrates the top side of an example embodiment of the improved locking device. The improved securing and monitoring device 15 comprises a housing 1 that houses a battery 4, electronic transmission components 2 (electronic transmission elements) for internal and/or external interaction, as well as for transmission of data to and from different types of sensors integrated within or external to the device. The wherein the electronic transmission elements 2 are configured to perform a wide variety of functions, wired or wirelessly, with a fastening system on the device.

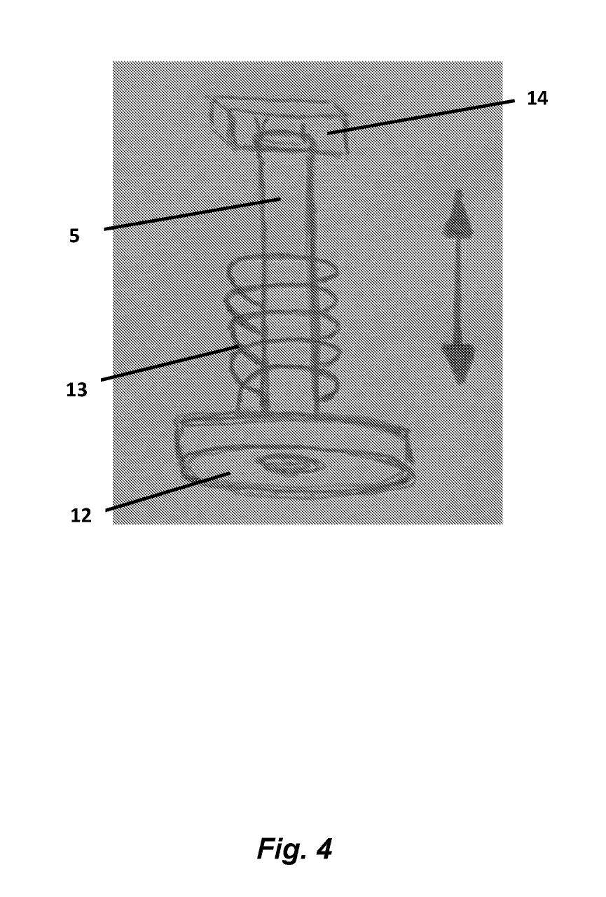

The innovative fastening system of the monitoring and securing device 15 is adjustable when it operates, that is, it allows compression and elongation of the components to adapt to the topography of the surfaces that are being connected by the respective movable entity's cargo locking mechanism and maintains contact and locking on both sides of the seal being formed. In an example embodiment, the improved fastening system comprises two or more fastening mechanisms as detailed in FIG. 4. The fastening mechanism shown in FIG. 4 is formed by a guide shaft 5 secured at one end to one or several fasteners 12, preferably magnets, and at the other end to a contact sensor 14. The fastening mechanism also incorporates a spring 13 that provides stability to the mechanism. The fasteners 12 shown in FIG. 4 are also present and indicated as fasteners 9 in FIG. 2. (There are fasteners 2 and 9 in FIG. 2.) There are fasteners on both sides of the device 15 so that they can attach to both sides of the movable entity's sealing connection (such as both doors).

The contact sensor 14 of the fastening system of the device 15 is activated and deactivated by the compression and elongation movement of the fastening system. In this manner, it provides information to other sensors and the electronic transmission elements 2 to detect whether the monitoring and securing device 15 has been installed, uninstalled, or removed from the cargo locking mechanism of the movable entity.

In an example embodiment, the fastening system of the device 15 is comprised of two fastening mechanisms whose fasteners 12 are located at one end of the housing 1 and six fastening mechanisms whose fasteners 9 are located at the other end of the housing 1. Therefore, the group of fasteners 12 secures one side of the sealing connection of the movable entity's cargo locking mechanism and the group of fasteners 9 secures the other side of the sealing connection. In a typical example environment, the locking mechanism of a movable entity's cargo container is composed of two doors 16 and 17 that close the cargo container, as shown in FIG. 5, so that fasteners 12 will be secured to the door 17 and fasteners 9 will be secured to the door 16.

In one example embodiment, fasteners 9 and 12 may be located proximate to (placed next to, nearby, or on) a number of electronic optical, contact and distance measuring sensors, for example, generally illustrated as sensors 7 and 8 in FIG. 2. Sensors 7 and 8 can identify and detect whether the monitoring and securing device 15 has been, for example, installed, uninstalled, or removed from the doors 16 and 17.

The monitoring and securing device 15 may include a cover-protector 6 as shown in FIGS. 2 and 3, which moves in the direction of fastening to avoid entry of unwanted elements and to protect sensors such as sensors 7 and 8. Such movement of cover-protector 6 is guided by the shaft 5 located inside the housing 1. The fasteners of housing 1, e.g., fasteners 9 and 12, are covered and protected by the side edge of the housing 1 and the cover-protector 6.

Electronic transmission elements 2 include cellular, satellite, Bluetooth, ZigBee and similar transmission and communication elements. These allow the monitoring and securing device 15 to receive data from sensors of the device 15 or from external sensors located on the movable entity, and to transmit these data to another location, such as a control tower. In some embodiments, the data includes GPS location information with latitude and longitude coordinates so that a monitoring system can monitor and identify any movement of the movable entity's locking mechanism and the location of the movable entity.

The monitoring and securing device 15 may also have impact sensors and accelerometers that detect anything installed or located on the doors according to a desired orientation and inform whether such desired orientation has been altered or modified in order to raise alerts or notifications. These alerts can detect, for example, if the doors have been tampered with.

Additionally, the monitoring and securing device 15 allows connection with external sensors, for instance, temperature, humidity, light intensity measuring sensors, among others, which measure environmental variables across the doors. The connection of the device 15 with external sensors may be achieved using a wired connection, using the connector 11 located on the back of the housing 1, or wirelessly, using an RF transmitter, Bluetooth, ZigBee or other known communication systems, generally identified as part of electronic transmission elements 2.

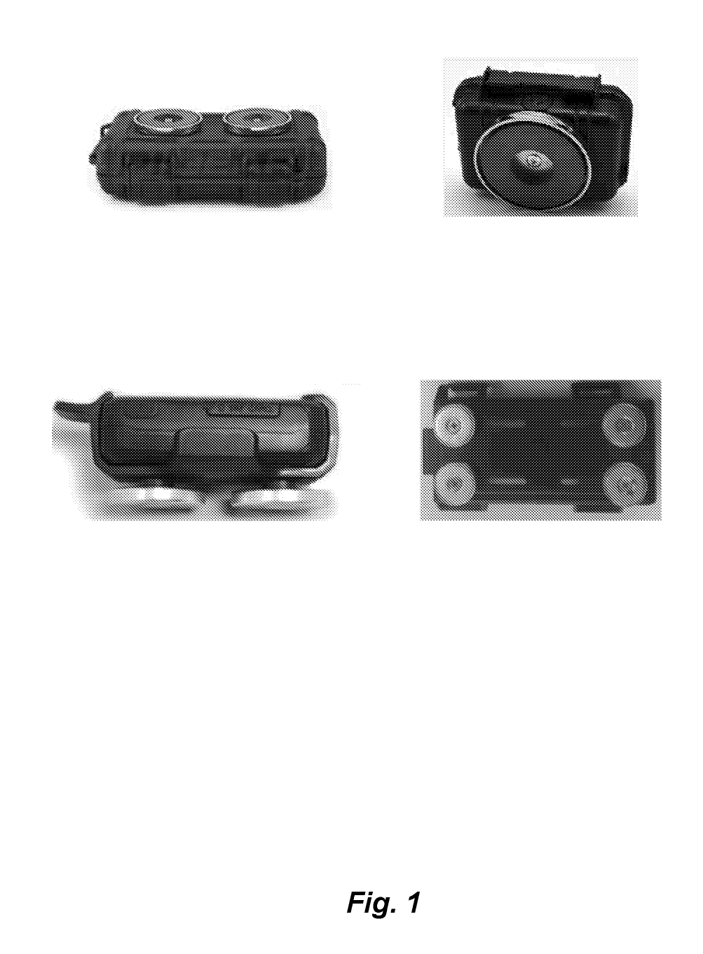

FIG. 5 illustrates an exemplary way in which the improved locking device is installed on the binding of a locking mechanism of the cargo area of a mobile asset to monitor and secure a cargo area of the mobile asset. As explained above, the improved monitoring and securing device 15 is fastened to, for example, doors 16 and 17 using fasteners 9 and 12 described with reference to FIG. 1-4.

Additional Considerations and Use with a Cargo Monitoring System

As described above, the monitoring and securing device may include multiple sensors for allowing the monitoring and tracing of mobile entities, for example for position, estimated time of arrival, and the like, but also to detect and monitor proper or improper installation and removal of the device, doors opening or closing, doors leaning, impact, tilt, shock or impact, light intensity, temperature, humidity, among others telemetry capacities. It also may have or connect to elements to transmit alarms and data wirelessly using a radio, cellular, modems or/and satellite transmission, including location coordinates with GPS and/or other positioning systems. In some embodiments, these sensors can interact with a cargo monitoring system (CMS) to process these conditions. In some embodiments, thus, the monitoring and securing device acts as a “smart lock.” In other embodiments this device is used standalone and may not be connected to a cargo monitoring system or may only be connected to portions of one. In other embodiments only some of the sensors described here may be included in the lock described in FIGS. 2-5.

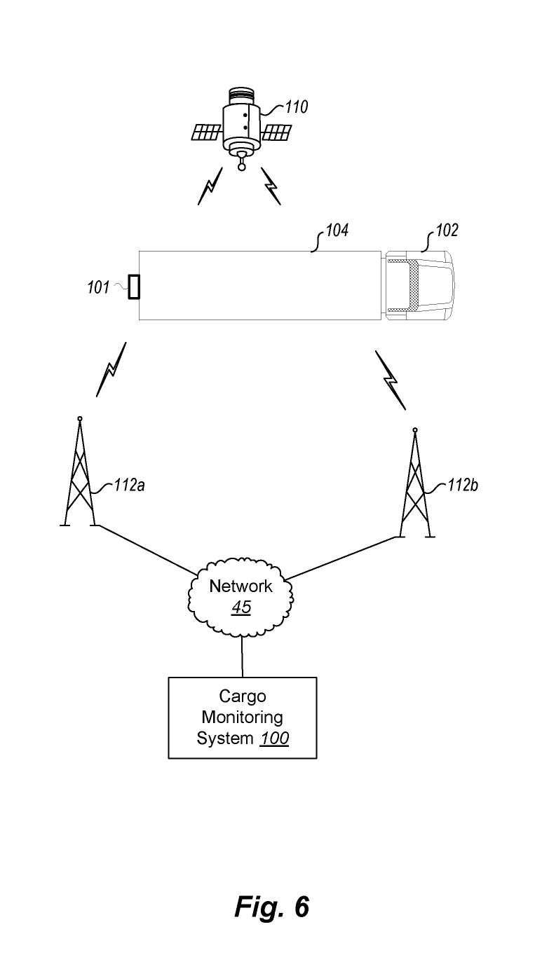

FIG. 6 is an example block diagram of a cargo monitoring system that is able to operate with the device shown in FIGS. 2 and 3. FIG. 6 shows a cargo monitoring system (“CMS”) 100 that is configured to track the movement of cargo, determine whether the cargo has departed or deviated from a specified route, and transmit notifications regarding such deviations or other conditions. In the illustrated example, a truck 102 carries a cargo container 104 that is secured with a smart lock 101. The smart lock 101, which can be implemented as the monitoring and securing device shown in FIGS. 2 and 3, determines the current location of truck 102, for example, based on a signal obtained from a GPS satellite 110. The smart lock 101 may also or instead determine the truck's location based on other information, such as cellular network location information, wireless network location information, road-side beacons, or the like. The smart lock 101 then transmits conditions and information (including an indication of its current location) for example via cellular equipment 112 and a corresponding network 45 to the system 100. The smart lock 101 may also or instead use other network facilities, such as Wi-Fi, Bluetooth, or the like. The conditions information transmitted by the smart lock 101 may include other information, including lock state, temperature, acceleration, position, inclination, and the like.

In general, and as described further below, the CMS 100 detects, identifies or determines anomalous conditions or events based on the conditions information received from smart locks such as smart lock 101. Such events may include deviations from a predicted or planned route of travel, the occurrence of a U-turn, a lock intrusion, attempted door removal (from a container), excessive speed, stopping in known dangerous locations, and the like. When such events/conditions are identified by the CMS 100, the CMS 100 transmits notifications, which may include messages, alarms, alerts, or the like. The CMS 100 may provide a hierarchy or escalation structure of notifications or actions that are performed in response to detected anomalous conditions, such as using text messaging to transmit informational messages and initiating telephone calls to transmit warnings or alarms (e.g., for detected intrusions).

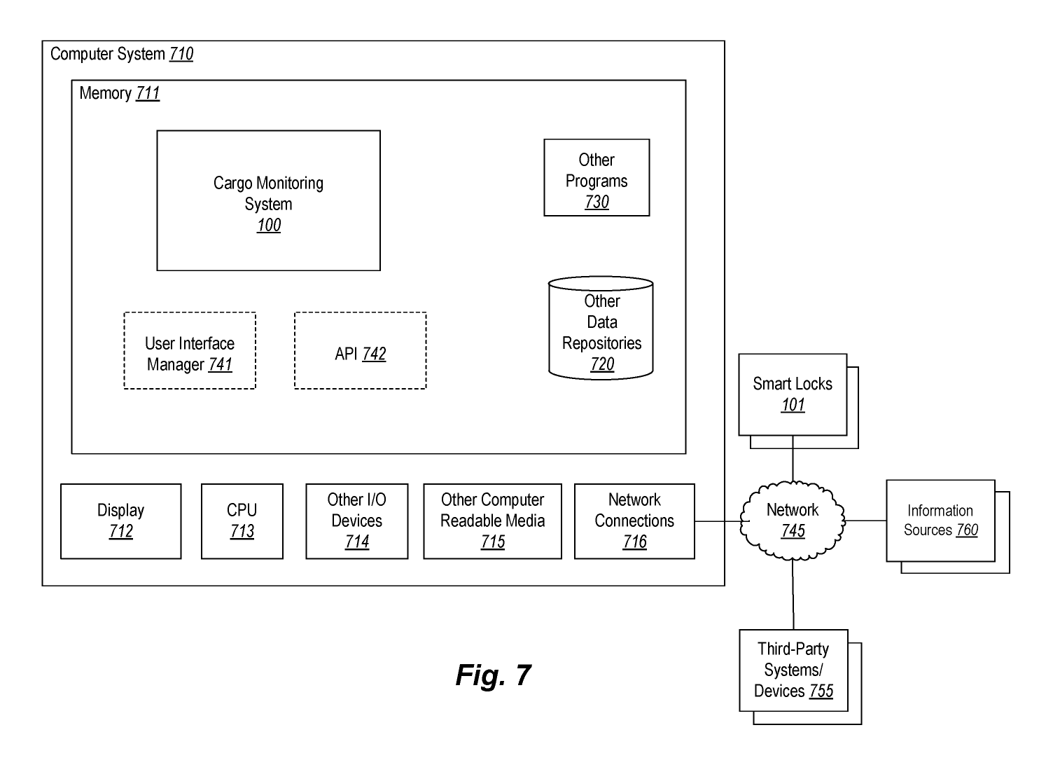

An example computer system used to implement aspects of a Cargo Monitoring System that operates with FIGS. 2 and 3 is illustrated in FIG. 7. FIG. 7 is an example block diagram of an example computing system. It may be used for implementing a cargo monitoring system integrating the lock shown in FIGS. 2 and 3 according to an example embodiment. In particular, FIG. 7 shows a computing system 710 that may be used to implement the CMS 100 of FIG. 6. Also, at least some of the implementation techniques described below with respect to the CMS 100 may be used to implement other devices, systems, or modules described herein.

Note that one or more computing systems/devices may be used to implement the CMS 100 (or some portions of the lock described above, for example systems used to transmit data to and from locks as described above). In addition, the computing system 710 may comprise one or more distinct computing systems/devices and may span distributed locations. Furthermore, each block shown may represent one or more such blocks as appropriate to a specific embodiment or may be combined with other blocks. Also, the blocks may be implemented in software, hardware, firmware, or in some combination to achieve the capabilities described herein.

In the embodiment shown, computing system 710 comprises a computer memory (“memory”) 711, a display 712, one or more Central Processing Units (“CPU”) 713, Input/Output devices 714 (e.g., keyboard, mouse, CRT or LCD display, and the like), other computer-readable media 715, and network connections 716. The CMS 100 is shown residing in memory 711. In other embodiments, some portion of the contents, some or all of the components of the CMS 100 may be stored on and/or transmitted over the other computer-readable media 715. The components of the CMS 100 preferably execute on one or more CPUs 713 and perform the techniques described herein. Other code or programs 30 (e.g., an administrative interface, a Web server, and the like) and potentially other data repositories, such as data repository 720, also reside in the memory 711, and preferably execute on one or more CPUs 713. Of note, one or more of the components in FIG. 5 may not be present in any specific implementation. For example, some embodiments may not provide other computer readable media 715 or a display 712.

The CMS 100 is shown executing in the memory 711 of the computing system 710. Also included in the memory are a user interface manager 741 and an application program interface (“API”) 742. The user interface manager 741 and the API 742 are drawn in dashed lines to indicate that in other embodiments, functions performed by one or more of these components may be performed externally to the CMS 100.

The UI manager 7 41 provides a view and a controller that facilitate user interaction with the CMS 100 and its various components. For example, the UI manager 741 may provide interactive access to the CMS 100, such that users can interact with the CMS 100, such as by specifying routes, tracking cargo, specifying contact information for notifications, and the like. In some embodiments, access to the functionality of the UI manager 741 may be provided via a Web server, possibly executing as one of the other programs 730. In such embodiments, a user operating a Web browser executing on one of the devices 55 can interact with the CMS 100 via the UI manager 741.

The API 742 provides programmatic access to one or more functions of the CMS 100. For example, the API 742 may provide a programmatic interface to one or more functions of the CMS 100 that may be invoked by one of the other programs 730 or some other module. In this manner, the API 742 facilitates the development of third-party software, such as user interfaces, plug-ins, adapters (e.g., for integrating functions of the CMS 100 into Web applications), and the like.

In addition, the API 742 may be in at least some embodiments invoked or otherwise accessed via remote entities, such as code executing on one of the locks 101, information sources 760, and/or one of the third-party systems/devices 755, to access various functions of the CMS 100. For example, an information source 760 may push map-related information, bills of lading, cargo manifests, route information, or the like, to the CMS 100 via the API 742. The API 742 may also be configured to provide management widgets (e.g., code modules) that can be integrated into the third-party systems/devices 755 and that are configured to interact with the CMS 100 to make at least some of the described functionality available within the context of other applications (e.g., mobile apps).

The CMS 100 interacts via the network 745 with locks 101, information sources 760, and third-party systems/devices 755. The network 745 may be any combination of media (e.g., twisted pair, coaxial, fiber optic, radio frequency), hardware (e.g., routers, switches, repeaters, transceivers), and protocols (e.g., TCP/IP, UDP, Ethernet, Wi-Fi, WiMAX) that facilitate communication between remotely situated humans and/or devices. The third-party systems/devices 755 may include any systems that provide data to, or utilize data from, the CMS 100, including Web browsers, shipping services, map services, notification services (e.g., for text messaging, emails, telephone calls), and the like.

In an example embodiment, at least some components/modules of the CMS 100 are implemented using standard programming techniques. For example, the CMS 100 may be implemented as a “native” executable running on the CPU 713, along with one or more static or dynamic libraries. In other embodiments, the CMS 100 may be implemented as instructions processed by a virtual machine that executes as one of the other programs 730. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), and declarative (e.g., SQL, Prolog, and the like).

The embodiments described above may also use either well-known or proprietary synchronous or asynchronous client-server computing techniques. Also, the various components may be implemented using more monolithic programming techniques, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously, and communicate using message passing techniques. Equivalent synchronous embodiments are also supported. Also, other functions could be implemented and/or performed by each component/module, and in different orders, and by different components/modules, yet still achieve the described functions.

In addition, programming interfaces to the data stored as part of the CMS 100, such as in the data stores 720, can be available by standard mechanisms such as through C, C++, C#, and Java APIs; libraries for accessing files, databases, or other data repositories; through scripting languages such as XML; or through Web servers, FTP servers, or other types of servers providing access to stored data. The data store 720 may be implemented as one or more database systems, file systems, or any other technique for storing such information, or any combination of the above, including implementations using distributed computing techniques.

Different configurations and locations of programs and data are contemplated for use with techniques of described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, and the like). Other variations are possible. Also, other functionality could be provided by each component/module, or existing functionality could be distributed amongst the components/modules in different ways, yet still achieve the functions described herein.

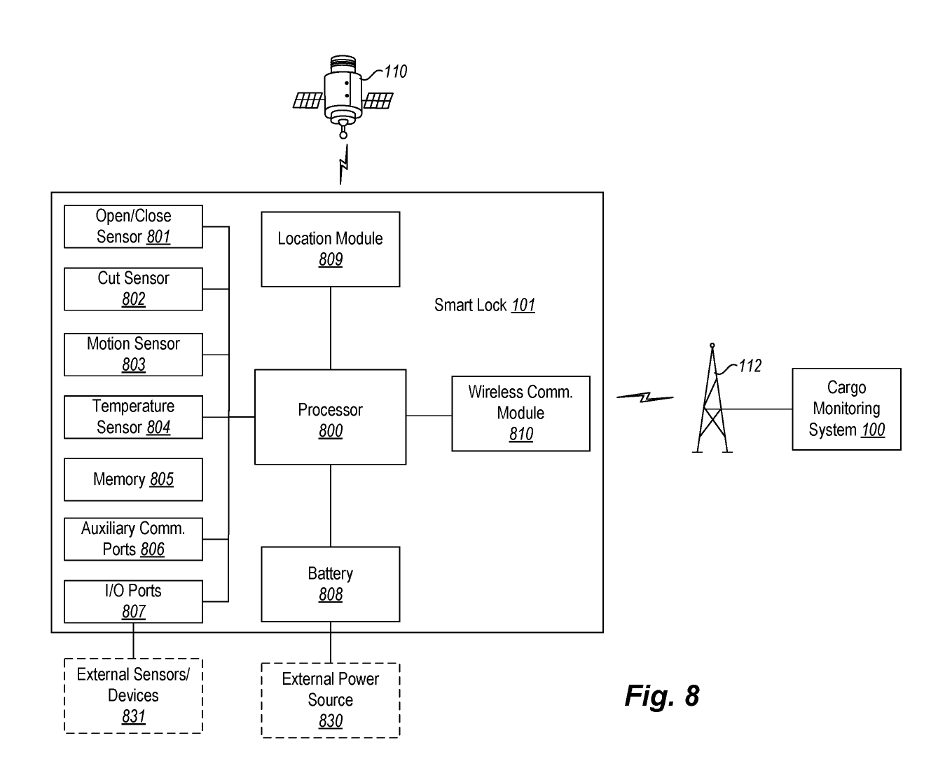

FIG. 8 is a block diagram showing sensing components of an example smart lock according to an example embodiment. FIG. 8 shows the sensor related system aspects of a lock 101 as described herein with respect to FIGS. 2-5. The illustrated lock 101 includes a processor 800, an open/close sensor 801, a cut sensor 802, a motion sensor 803, a temperature sensor 804, a memory 805, auxiliary communication ports 806, I/O ports 607, a battery 808, a location module 809, and a wireless communication module 810.

The processor 800 may be a stand-alone CPU, a microcontroller, a system on a chip, or the like. The processor is in signal communication with the components 801-810, such as via a data bus, dedicated data ports, or the like. The processor executes instructions that implement one or more of the techniques described herein, such as battery monitoring, power save functions, communication functions, temperature monitoring, data storage, and the like. The instructions may be stored in and loaded form the memory 805 and/or in a memory (not shown) that is internal to the processor 800. The processor 800 communicates with the illustrated components by polling, interrupts, message passing, or the like.

The sensors 801-804 monitor the state of the lock 101 and/or the cargo. The sensors provide monitoring information to the processor 800, such as by raising interrupts, storing information directly in memory 804, or the like. The processor 800 may evaluate the received information, such as by determining whether data values or measurements are out of an acceptable range, and then transmitting a notification to the CMS 100.

The open/close sensor 801 is responsible for monitoring the open/closed state of the lock, and notifying the processor of state changes. The cut sensor 802 monitors the mechanical integrity of the casing and/or arms of the lock 101, in order to detect if the lock is breached or the arms are cut.

The motion sensor 803 may include one or more of an accelerometer, inclinometer, vibration sensor, or the like. The motion sensor 803 provides information about the motion of the lock to the processor 800.

The temperature sensor 804 monitors the internal and/or external temperatures of the lock. In some embodiments, an external temperature probe may be positioned inside of the cargo unit. The sensor 804 may receive readings from an external temperature sensor via I/O ports 807.

The memory 805 is responsible for storing data and/or instructions related to the operation of the lock 101. The memory 805 may be or include one or more of volatile memory (e.g., RAM), non-volatile memory (e.g., ROM), Flash memory, or the like. The memory 805 may serve as a buffer, record, or medium for data values provided by the sensor 801-804 or other components.

The ports 806 and 807 allow the lock 101 to communicate with external sensors, devices or systems 631. For example, the communication ports 806 may include USB ports, serial ports, Ethernet ports, or the like. As another example, the I/O ports 807 may be connected to an external temperature or humidity sensor.

The battery 808 provides power to the processor 808 and other components of the lock. The battery 808 is also in signal communication with the processor 808, so that the battery level can be monitored and the function of the battery can be controlled. The battery 808 also includes an external port that can be connected to an external power source 630, so that the lock 101 can be charged without opening it.

The location module 809 obtains and provides location information for the lock 101. The location module 809 may include a GPS unit and corresponding antenna configured to receive signals from one or more satellites 810.

The wireless communication module 810 performs wireless communication functions for the lock 101. The communication module 809 may include a radio, modem, identity information (e.g., SIM card), and the like, so as to communicate via a cellular network 112 with the cargo monitoring system 100. Other types of wireless communication may be supported, including Wi-Fi, satellite, or the like.

At least some elements of the smart lock 101 may be implemented as software using standard programming techniques, such as those discussed with respect to the implementation of the CMS 100 in FIG. 7, above. In addition, some embodiments of the smart lock 101 may include a greater or lesser number of components than those shown here. For example, some smart locks may not include a cut sensor 802, relying instead on a vibration sensor or other techniques to detect lock breaches.

Furthermore, in some embodiments, some or all of the components of the CMS 100 and/or smart lock 101 may be implemented or provided in other manners, such as at least partially in firmware and/or hardware, including, but not limited to one or more application-specific integrated circuits (“ASICs”), standard integrated circuits, controllers executing appropriate instructions, and including microcontrollers and/or embedded controllers, field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques. Some or all of the components and/or data structures may be stored on tangible, non-transitory storage mediums. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

Also, although certain terms are used primarily herein, other terms could be used interchangeably to yield equivalent embodiments and examples. In addition, terms may have alternate spellings which may or may not be explicitly mentioned, and all such variations of terms are intended to be included.

Example embodiments described herein provide applications, tools, data structures and other support to implement a improved monitoring and securing device. Other embodiments of the described techniques may be used for other purposes. In this description, numerous specific details are set forth, such as data formats and code sequences, etc., in order to provide a thorough understanding of the described techniques. The embodiments described also can be practiced without some of the specific details described herein, or with other specific details, such as changes with respect to the ordering of the logic, different logic, etc. Thus, the scope of the techniques and/or functions described are not limited by the particular order, selection, or decomposition of aspects described with reference to any particular routine, module, component, and the like.

All of the above U.S. patents, U.S. patent application publications, U.S. patent applications, foreign patents, foreign patent applications and non-patent publications referred to in this specification and/or listed in the Application Data Sheet, including but not limited to U.S. Provisional Patent Application No. 62/251,584, filed Nov. 5, 2015; and U.S. Provisional Patent Application No. 62/251,577, filed Nov. 5, 2015, which applications are incorporated herein by reference in their entireties

From the foregoing it will be appreciated that, although specific embodiments have been described herein for purposes of illustration, various modifications may be made without deviating from the spirit and scope of the invention. For example, the monitoring and securing device discussed herein is applicable to other architectures other than the cargo monitoring system described in FIGS. 6 and 8. Also, the methods and systems discussed herein are applicable to differing protocols, communication media (optical, wireless, cable, etc.) and devices (such as wireless handsets, electronic organizers, personal digital assistants, portable email machines, game machines, pagers, navigation devices such as GPS receivers, etc.).

1. A monitoring and securing device having at least two ends, a first end for attaching to a first surface on a mobile vehicle, a second end for attaching to a second surface of the mobile vehicle, the first and the second surfaces configured to be closed to form a connection to seal a cargo carrying area, comprising:
a housing;
a battery;
a fastening mechanism, comprising:
a plurality of fasteners, wherein at least a first fastener is configured to be attachable to the first surface, wherein at least a second fastener is configured to be attachable to the second surface, and wherein each fastener is attached to a spring which compresses and elongates along a guide shaft to allow the housing to contract and expand as required to pull the first surface towards the second surface to close the cargo carrying area;
a first contact sensor attached at a distal end to the spring that attaches to the first fastener at a proximal end, configured to detect when the first fastener has been installed incorrectly, released, or removed from the first surface; and
a second contact sensor attached at a distal end to the spring that attaches to the second fastener at a proximal end, configured to detect when the second fastener has been installed incorrectly, released or removed from the first surface; and
electronic transmission element that is configured to received sensing data from the contact sensors attached to the first fastener and the second faster that, upon receiving notification that either the first fastener or the second fastener has been removed or tampered with, causes an alert,
wherein the battery, fastening mechanism, and electronic transmission element is secured in the housing.

2. The device of claim 1 wherein the first fastener and/or the second faster are magnets.

3. The device of claim 2 wherein the first and/or second surfaces are metal doors.

4. The device of claim 1 wherein the electronic transmission elements communicate the alert wirelessly.

5. The device of claim 4 wherein the alert is transmitted to a cargo monitoring system used to detect when a lock securing a cargo has been tampered with or removed.

6. The device of claim 1 wherein the plurality of fasteners include two located on the first end of the device and six located on the second end of the device.

7. The device of claim 1 further comprising additional sensors attached to the device proximate to the first fastener and/or the second fastener, wherein the additional sensors detect opening or closing of doors of the mobile vehicle, opening or closing of a locking mechanism attached to the mobile vehicle, removal of the doors, and/or door leaning.

8. The device of claim 1 wherein the first and second surfaces are doors and wherein the first door is at a different depth position when closed relative to a second door such that the doors do not create a seal and instead create a gap when closed without the device.

9. A non-transitory computer-readable memory medium comprising instructions for controlling a computer processor, when executed to perform a method comprising:
receiving information from a contact sensor attached to a fastener of a fastening mechanism of a monitoring and securing device, the fastener attaching to a door of a mobile vehicle that is positioned at a depth that is different from a second door of the mobile vehicle;
determining that the received information indicates that the monitoring and securing device has been tampered with, or installed incorrectly, removed;
generating an alert commensurate with the determination that the monitoring and securing device has been tampered with, or installed incorrectly, removed; and
communicating the generated alert wirelessly.

10. The memory medium of claim 9 wherein the method further comprises sending the generated alert wirelessly to a cargo monitoring system.

11. The memory medium of claim 9 wherein the memory medium is embedded in the monitoring and securing device and wherein the contact sensor is attached to the fastener of the device by a spring that compresses and expands when the fastening mechanism is attached to irregular surfaces being joined.

12. The memory medium of claim 9 wherein the alert is communicated wireless by RF signal, satellite, or cellular network.
